(19) United States
(12) Patent Application Publication
(10) Pub. No.: US 2021/0019210 A1
(43) Pub. Date: Jan. 21, 2021

(54) SYSTEM AND METHOD OF ELIMINATING OPERATIONAL PROBLEM OF SERVICES IN A DATA TRANSMISSION NETWORK CONTAINING VIRTUAL MACHINES

(71) Applicant: AO Kaspersky Lab, Moscow (RU)

(72) Inventor: Evgeny V. Bushtyrev, Moscow (RU)

(21) Appl. No.: 16/774,542

(22) Filed: Jan. 28, 2020

(30) Foreign Application Priority Data
Jul. 17, 2019 (RU) 2019122434

(51) Int. Cl. G06F 11/07; G06F 9/455; G06F 8/30; G06F 8/40

(52) U.S. Cl. CPC G06F 11/079; G06F 11/0712; G06F 11/0751; G06F 2009/45591; G06F 9/45558; G06F 8/30; G06F 8/40; G06F 11/0793

(57) ABSTRACT

Disclosed herein are systems and methods for eliminating problems in operations of data processing services in a data transmission network containing virtual machines. In one aspect, an exemplary method comprises, identifying, by a problem identifier, an operational problem of at least one data processing service, determining, by an analyzer, a set of actions for diagnosing the operational problem and for determining a cause, identifying, by the problem identifier, the cause of the operational problem, eliminating, by an assembler, the cause of the operational problem, and determining, by the problem identifier, whether the operational problem of the data processing service has been successfully eliminated based on data containing the results of the execution of the executable files.

### CROSS REFERENCE TO RELATED APPLICATIONS

The present application claims priority to Russian Patent Application No. 2019122434, filed on Jul. 17, 2019, the entire content of which is incorporated herein by reference.

### FIELD OF TECHNOLOGY

The present disclosure relates to the field of data processing services, more specifically, to systems and methods of eliminating problems in operations of data processing services in a data transmission network containing virtual machines.

### BACKGROUND

Security services for virtual machines (such as Kaspersky Security for Virtualization) are software products designed for controlling virtual machines, and for monitoring and providing the security of virtual machines. However, such software products are tested by the maker of the software on a limited number of virtual environments running on virtual machines. The software products are intended to subsequently be used in information systems of clients. However, there are a substantial number of factors present in the client environment that affect the normal operations of the security services that are being provided for the virtual machines and for the services running in the virtual environments. Consequently, problems arise with the operation of the security services in the client environment.

One approach for diagnosing virtual machines is using a system in which a hypervisor receives a message from an agent of a virtual machine as to an error and determines actions to be taken based on the received message. However, this approach is geared only to detection of the existence of an operation problem and not the cause. The origin of the problem is not addressed by this and similar approaches. Moreover, for information systems operating in complex distributed environments, it is harder to gather data for diagnosing problem arising with operation of the services. Any effort to gather the data would require actions to be taken on various network elements of the data transmission network and on the virtual machines. For example, gathering logs of system events, polling current statuses of the security service for the virtual machines, determining the status of the data transmission network, monitoring the execution of applications and services, and the like, may be necessary. In addition, these actions to be taken on various network elements tend to require manual operation by a user, routine and repetitive in nature, and quite slow when being carried out.

Thus, there is a need for a more optimal way to diagnose malfunctions and limits to operability of services in data transmission networks when using security services in networks with virtual machines.

### SUMMARY

Aspects of the disclosure relate to eliminating problems in data processing services, more specifically to systems and methods for eliminating problems in operations of data processing services in a data transmission network containing virtual machines.

In one exemplary aspect, a method for eliminating problems in operations of data processing services in a data transmission network containing virtual machines is implemented in a computer comprising a hardware processor, the method comprising: identifying, by a problem identifier, an operational problem of at least one data processing service, determining, by an analyzer, a set of actions for diagnosing the operational problem and for determining a cause, identifying, by the problem identifier, the cause of the operational problem, eliminating, by an assembler, the cause of the operational problem, and determining, by the problem identifier, whether the operational problem of the data processing service has been successfully eliminated based on data containing the results of the execution of the executable files.

According to one aspect of the disclosure, a system is provided for eliminating problems in operations of data processing services in a data transmission network containing virtual machines, the system comprising a hardware processor configured to: identify, by a problem identifier, an operational problem of at least one data processing service, determine, by an analyzer, a set of actions for diagnosing the operational problem and for determining a cause, identify, by the problem identifier, the cause of the operational problem, eliminate, by an assembler, the cause of the operational problem, and determine, by the problem identifier, whether the operational problem of the data processing service has been successfully eliminated based on data containing the results of the execution of the executable files.

In one exemplary aspect, a non-transitory computer-readable medium is provided storing a set of instructions thereon for eliminating problems in operations of data processing services in a data transmission network containing virtual machines, wherein the set of instructions comprises instructions for: identifying, by a problem identifier, an operational problem of at least one data processing service, determining, by an analyzer, a set of actions for diagnosing the operational problem and for determining a cause, identifying, by the problem identifier, the cause of the operational problem, eliminating, by an assembler, the cause of the operational problem, and determining, by the problem identifier, whether the operational problem of the data processing service has been successfully eliminated based on data containing the results of the execution of the executable files.

In one aspect, the identifying of the cause of the operational problem comprises: creating, by the assembler, at least one executable file for performing the diagnosis based on the determined set of actions, executing, by the assembler, the created executable files on resources connected with the data processing service for performing the diagnosis of the cause, identifying, by the problem identifier, the cause of the operational problem of the data processing service based on results of the execution of the executable file.

In one aspect, the eliminating of the cause of the operational problem comprises: identifying, by the analyzer, a set of actions for eliminating the operational problem, creating, by the assembler, at least one executable file for eliminating the cause of the operational problem, and executing, by the assembler, the created executable files for eliminating the cause of the operational problem on one or more resources connected with the data processing service. In one aspect, the method is repeated until the cause of the operational problem is eliminated.

In one aspect, a resource of the one or more resources connected with the data processing service comprises one of: an element of the data transmission network, a virtual machine, and a controller on which the security service for virtual machines is running.

In one aspect, the executable file has no dependencies on software packages or dynamic libraries.

In one aspect, the method further comprises: transforming, by the analyzer, the set of action into a source code. and providing the source code to the assembler.

In one aspect, the creation of the at least one executable file is further based on at least one of: information gathered from agents located on a virtual machine, information gathered from agents located on elements of the data transmission network, and information obtained from a user of an element of the data transmission network.

In one aspect, the data processing service is running on one or more virtual machines.

In one aspect, the operational problem is a total inoperability of the data processing service.

In one aspect, the operational problem is a partial inoperability of the data processing service.

In one aspect, the method of the present disclosure eliminates problems in operations of data processing services of data transmission network that contain virtual machines. The method is designed to improve diagnostics of problems in networks—thereby enabling security services to be delivered without affecting normal operations of networks that include virtual machines.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example of a data transmission network containing virtual machines in accordance with aspect of the present disclosure.

FIG. 2 illustrates an exemplary realization of a system for eliminating problems in operations of data processing services in a data transmission network containing virtual machines in accordance with aspect of the present disclosure.

FIG. 3 illustrates an exemplary method for eliminating problems in operations of data processing services in a data transmission network containing virtual machines in accordance with aspects of the present disclosure.

FIG. 4 presents an example of a general purpose computer system on which aspects of the present disclosure can be implemented.

### DETAILED DESCRIPTION

Exemplary aspects are described herein in the context of a system, method, and a computer program for eliminating problems in operations of data processing services in a data transmission network containing virtual machines. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

In order to present the teachings of the present disclosure with clarity, the following term/concept, as used in describing various aspects of the disclosure, is defined herein.

A hypervisor (a monitor of virtual machines) is a program creating an operational environment for other programs (including other hypervisors) by simulating computer hardware and controlling that hardware and the guest operating systems operating in that environment.

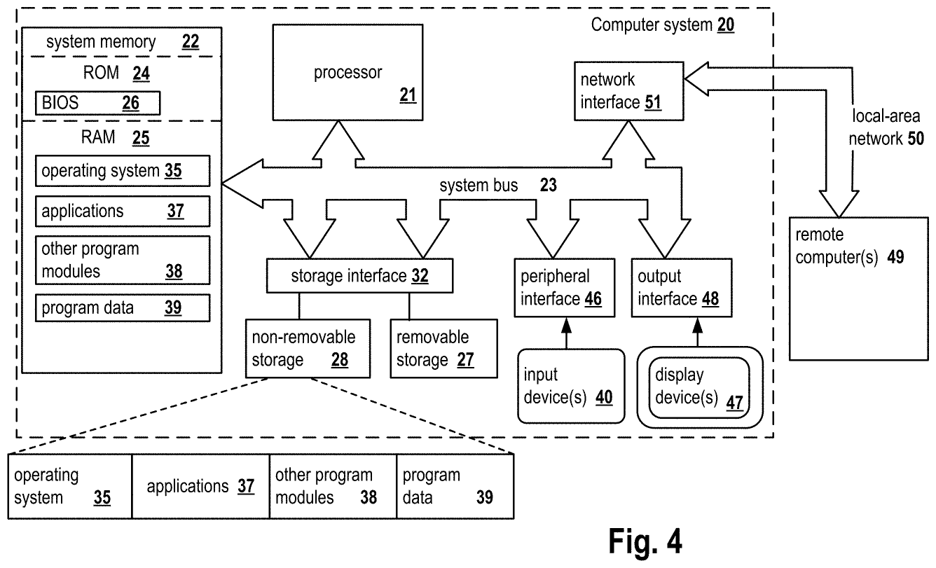

In one aspect, the present disclosure describes a system for eliminating problems in operations of data processing services in a data transmission network containing virtual machines that is implemented on a computing system (e.g., a server, computer, etc.), that includes real-world devices, systems, components, and groups of components realized with the use of hardware such as integrated microcircuits (application-specific integrated circuits, ASICs) or field-programmable gate arrays (FPGAs) or, for example, in the form of a combination of software and hardware such as a microprocessor system and set of program instructions, and also on neurosynaptic chips. The functionality of such means of the system may be realized solely by hardware, and also in the form of a combination, where some of the functionality of the system means is realized by software, and some by hardware. In certain aspects, some or all of the components, systems, etc., may be executed on the processor of a general-purpose computer (such as the one shown in FIG. 4). Furthermore, the system components may be realized either within a single computing device or spread out among several interconnected computing devices.

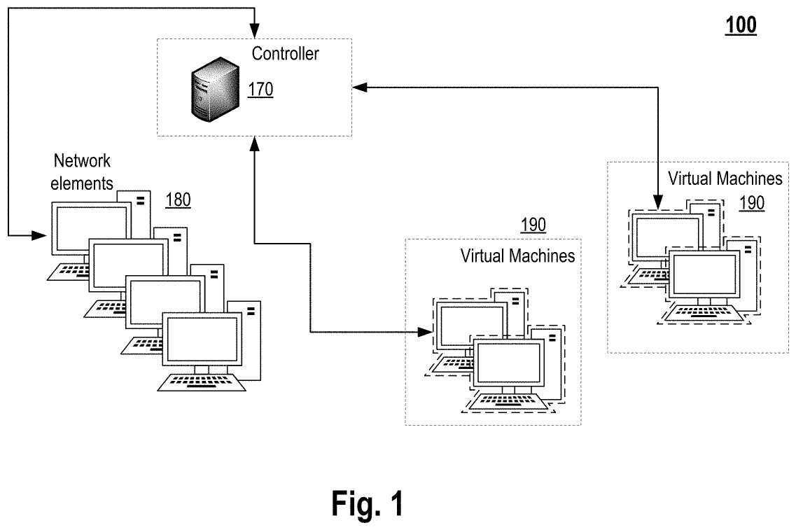

FIG. 1 illustrates an example of a data transmission network 100 containing virtual machines in accordance with aspect of the present disclosure. In one aspect, a data transmission network 100 comprises data transmission network elements 180 (such as computers, terminals, workstations), virtual machines 190, and at least one controller 170. The virtual machines 190 operate under the control of various hypervisors and run on designated computers or servers. In one aspect, the controller 170 runs on at least one designated computer (for example, on a server). The controller 170 provides settings to the virtual machines 190 and monitors their status, while the data transmission network elements 180 make requests to data processing services running in one or more virtual machines 190. An example of a controller 170 is a security service for virtual machines, in a particular instance, the software Kaspersky Security for Virtualization.

A data transmission network also often uses solutions that make use of the infrastructure of virtual desktops (Virtual Desktop Infrastructure, VDI), where a group of virtual desktops are created from a limited set of virtual machine images, wherein the created virtual desktops are located on the virtual machines 190. The group of virtual desktops are employed, by users, for different purposes. The virtual desktops may carry out the functions of elements 180 of the data transmission network. For example, the virtual desktops may be used to send requests to servers. The virtual machines 190 may then act on the requests. The controller 170 provides security to the virtual desktops.

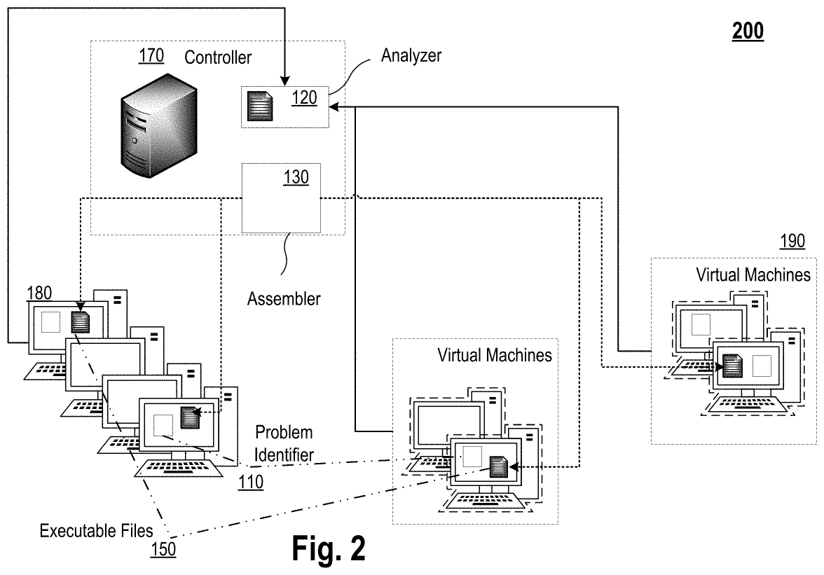

FIG. 2 illustrates an exemplary realization of a system 200 for eliminating problems in operations of data processing services in a data transmission network containing virtual machines in accordance with aspect of the present disclosure.

In one aspect, the system 200 contains a problem identifier 110, an analyzer 120 and an assembler 130.

The problem identifier 110, in one aspect, is a component of the security service for virtual machines. The problem identifier 110 is used to identify an operational problem of at least one data processing service running in one or more of the protected virtual machines 190 (hereafter in the present disclosure, a data processing service). In one aspect, the identified operational problem of the data processing service is a total or a partial inoperability of the service. In one aspect, the operational problem is identified when a response to a request is not received from the data processing service in a pre-determined time interval (i.e., in a reasonable time for the service). In other words, the problem manifests itself as a failure to receive a response from the data processing service to a request of the elements 180 of the data transmission network, inability to exchange network traffic with the data processing service, delay in receiving a response from the data processing service, and other scenarios.

In one aspect, the problem identifier 110 operates in real time and provides continuous monitoring of the status of the data transmission network and gathers information.

In another aspect, the problem identifier 110 begins to operate after a command from the controller 170 is received, the command indicating to begin/resume monitoring and problem identification.

In one aspect, the problem identifier 110 gathers information from agents located on the virtual machines 190.

In another aspect, the problem identifier 110 gathers information from agents located on the elements 180 of the data transmission network.

In one aspect, the problem identifier 110 obtains information from the user of the element 180 of the data transmission network. For example, the user is having an operational problem with the data processing service running in a virtual environment on a virtual machine 190. In response to the user reported operational problem, the problem identifier 110 is launched to gather data on the detected operational problem. In one aspect, the user reported operational problem comprises at least one of: elements 180 of the data transmission network being inaccessible, software crashes occurring during operation of one or more applications, the processor having a high workload, and so forth. Furthermore, in one aspect, the user selects the type of operational problems for which the problem identifier 110 is to be launched for the purpose of data gathering.

In one aspect, the problem identifier 110 receives information from an expert in IT security.

In one aspect, the problem identifier 110 sends, to the analyzer 120, the information received from one or more of: an agent located on the virtual machines 190, an agent located on the elements 180 of the data transmission network, a user of an element 180 of the data transmission network, an expert in IT security.

In one aspect, the analyzer 120 is a component of the security service for virtual machines. The analyzer 120 runs on at least one controller 170.

In one aspect, the analyzer 120 identifies a set of actions for diagnosing the operational problem using a decision tree and the data received from the problem identifier 110. In one aspect, the set of actions includes at least launching a script for execution.

In one aspect, the analyzer 120, in order to identify the set of actions, uses a model previously trained by at least one machine learning method. The machine learning method may be a method ordinarily known in the art.

In one aspect, the analyzer 120 identifies at least one set of actions, the actions being for at least one of:
diagnosis of the operability of the data processing service (including identification of the cause of the operational problem);
identification of methods of restoration of operability of the data processing service (i.e., identification of methods of eliminating the cause of the operational problem); and
restoration of the operability of the data processing service (eliminating the cause of the operational problem).

It should be noted that the set of actions needed for the diagnostics or restoration of the operability of the service may contain at least one of:
a set of actions which need to be performed on at least one element 180 of the data transmission network;
a set of actions which need to be performed on at least one virtual machine 190; and
a set of actions which need to be performed on at least one controller 170 on which the security service for virtual machines is running.

In one aspect, the analyzer 120 transforms the identified set of actions into source code, and sends the source code to the assembler 130.

In one aspect, the assembler 130 is a component of the security service for virtual machines. The assembler 130 operates on at least one controller 170 (a dedicated server or computer).

In one aspect, the assembler 130 creates at least one executable file 150 using the source code received from the analyzer 120, wherein the created executable code does not have dependencies after assembly (hereafter the output of the assembler is referred to simply as an executable file 150). In the context of the method of the present disclosure, an executable file 150 (having no dependencies) is an executable file whose execution does not require additional software packages or dynamic libraries (such as NET Framework, Python, PUP). For the operating systems of the Windows family, the executable file 150 may comprise an exe-file. For the operating systems of the Linux family, the executable file 150 may comprise a binary file (it is known that files in Linux are executable if they have authorization for execution). In one aspect, the executable file 150, having no dependencies, may be created with the aid of the Go Language environment (https://golang.org/).

In one aspect, the created executable file 150 is intended for execution on resources connected with the data processing service running in a protected virtual machine 190, the resource being at least one of:
an element 180 of the data transmission network;
a virtual machine 190; and
a controller 170 on which the security service for virtual machines is running.

It is to be understood that the executable file 150 is designed to identify or eliminate operational problem of the data processing service, where the cause of the operational problem of the data processing service is often not clear. Therefore, the installation of additional software on the resource connected with the data processing service might result in a distortion of the results of execution of the file 150 (for example, in the course of installing the additional software the resource may be restarted and the operational problem may be eliminated). In another scenario, new operational problems may be detected after the addition of the software, the new operational problems of the data processing service being unrelated to the previous operational problems (for example, the location on the system disk may be removed during the course of installing the software).

After the executable file 150 is created, the assembler 130 executes the executable file 150. For the placement and execution of the file 150, agents interacting with the problem identifier 110 may be used. In one variant aspect, the placement and execution of the file 150 are done using the Remote Desktop Protocol (RDP) or Secure Shell (SSH) protocols.

As a result of the execution of the file 150, actions that are needed to identify the operational problem (diagnostics) or eliminate the operational problem (restoration of operability) of the data processing service are performed. In one aspect, the result of the action being performed is sent to the analyzer 120.

In one aspect, the analyzer 120 identifies, if necessary, one or more other sets of actions based on the data received on the results of the actions performed after the execution of the file 150. The one or more other sets of actions are identified using a decision tree or a model previously trained by one or more machine learning methods or neural nets. The identification of the one or more other sets of actions may be necessary, for example, when the diagnostics has been performed or the inoperability of the data processing service has been corrected.

Thus, in one aspect, the analyzer 120 and the problem identifier 110 repeat the above described steps, as needed, by selecting actions, creating an executable file for the selected action, performing the actions, and returning to selection of other action, until the problem identifier 110, based on data containing the results of the execution of the created executable files, determines that the operational problem of the data processing service has been eliminated. Some practical examples of the operations of the described system 200 and the actions of the executable file 150 are provided below.

In one aspect, the executable file 150 may contain actions for checking the accessibility and effectiveness of usage of external services (such as those running on a protected virtual machine 190 or on a separate server in relation to the element 180 of the data transmission network on which the file 150 was launched). In one aspect, the external services may include at least one of:
product services with which the security service for virtual machines interacts, for example, a cloud security service (Kaspersky Security Network), a dump server, a security service for virtual machines (Kaspersky Security Center), and other services which the service or software residing on the same computing device as the file 150 accesses; and
external infrastructure services with which a product can interact, such as the services DHCP, DNS, hypervisors, OS utilities, wherein further diagnostics or data of other services may be obtained by accessing these external infrastructure services.

In another aspect, the executable file 150 may contain actions for accessing utilities of a specific hypervisor, under whose control a virtual machine 190 is running. The utilities constitute a set of programs that may enable obtaining, from a guest system of the virtual machine 190, certain more expansive information for: the given virtual machine 190 (such as the hardware configuration of the virtual machine 190) and the hypervisor under whose control the virtual machine 190 is running (such as the IP-address, the type of hypervisor). It is noted that knowing the versions of these utilities is important; some versions may conflict with the service or software situated on the same computing device as the executable file 150, causing its inoperability, or resulting in its slower execution (operation).

In yet another aspect, as a result of the execution of the executable file 150, the problem identifier 110 discovers that a firewall is blocking a port on an element 180 of the data transmission network. The analyzer 120 may then identify the set of actions to open the port and create a new executable file 150 (having no dependencies).

In one aspect, the executable file 150 may contain actions when performed will allow switching on/off of logs of a service or software situated on the same computing device as the executable file 150, and allows copying of those logs to a designated location in the data transmission network for further analysis.

In one aspect, the executable file 150 may contain actions that enable downloading of a software patch for a specific virtual machine 190 or a group of virtual machines 190, as a whole, and for the elements 180 of the data transmission network. For instance, the software patch may be needed for fixing a software problem.

In one aspect, the executable file 150 may contain actions that enable setting-up of a service or software situated on the same computing device as the executable file 150, such as when the analyzer 120 uses a decision tree to select a set of actions to solve a particular problem. For example, the size of the internal queues and various time characteristics (such as timeouts) for connection to the element 180 of the data transmission network or to the virtual machine 190 may be changed.

In one aspect, the executable file 150 may contain actions that enable an interaction with the user, for example, the action to be performed may change the settings or security levels. For example, the action may involve requesting permission from the user to restart the service or to turn on special operating modes of the service, in which the service is able to perform an expanded diagnostic as a result of lowering of the security level (for example, during the analysis there may appear in the logs confidential information needed for the analysis). Moreover, all unneeded data (such as the logs) may be automatically deleted after the completion of the execution of the executable file 150, since users often forget to do this deletion by themselves.

In one aspect, the executable file 150 interacts with the user: if the diagnostic actions require a narrowly specialized utility which is absent from the installation set of the security service for virtual machines, then, as one of the steps, the user may install the utilities (for example, the traffic interceptor Wireshark), after which the newly installed utility will be called up automatically and the obtained data, after processing by the analyzer 120, may be used for selecting further actions.

In one aspect, the executable file 150 establishes a link with one or more similar executable files 150 on different elements 180 of the data transmission network or the virtual machines 190. In one aspect, the links to the one or more similar executable files 150 are established for one or more of: to measure traffic speed (the speed of movement of network packets), to determine blocking of ports, to measure loss of packets, and to determine a presence of a firewall rule preventing traffic from going between different sections of the data transmission network or to a specific virtual local area networks (VLAN).

In one aspect, the executable file 150 analyzes entry points to an operating system for determining whether or not vulnerabilities are present. For instance, the analysis of entry points may be performed after checking the list of open ports and services using open ports. In one aspect, the analysis of entry points to an operating system may be performed using more specialized utilities, such as nmap.

In one aspect, the executable file 150 determines requirements on the operation of the service. For example the service may require certain open ports for operation (such as TCP:7777, UDP:9000).

In one aspect, the executable file 150 determines a status of the system, wherein the determined status includes at least one of: a workload of the CPU, a presence of free space on a disk, and so forth.

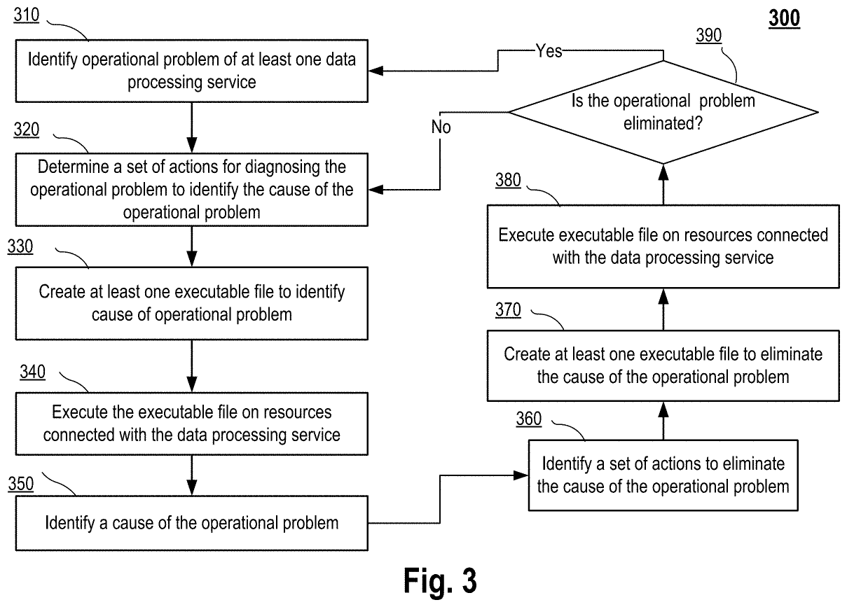

FIG. 3 illustrates an exemplary method 300 for eliminating problems in operations of data processing services in a data transmission network containing virtual machines in accordance with aspects of the present disclosure. The method 300 may be implemented on a computing system that comprises any number of devices, e.g., the system 200 described above.

In step 310, method 300, by the problem identifier 110, identifies an operational problem of at least one data processing service.

The data processing service is running on one or more virtual machines 190.

In one aspect, the operational problem is a total inoperability of the data processing service.

In one aspect, the operational problem is a partial inoperability of the data processing service.

In one aspect, the problem identifier 110 operates in real time and provides continuous monitoring of a status of the data transmission network and gathers information.

In one aspect, the problem identifier 110 begins to operate after a command from the controller 170 is received, the command being for beginning or resuming monitoring and/or identifying of operational problems.

In one aspect, the problem identifier 110 gathers information from agents located on the virtual machines 190.

In one aspect, the problem identifier 110 gathers information from agents located on elements 180 of the data transmission network.

In one aspect, the problem identifier 110 obtains information from the user of an element of the data transmission network.

In step 320, method 300, by the analyzer 120, determines a set of actions for diagnosing the operational problem to determine a cause, e.g., using a decision tree. In one aspect, the analyzer 120, identifies the set of actions for diagnosing the operational problem using a model previously trained by one of the machine learning methods. Then, the analyzer 120 identifies at least one set of actions needed for the diagnostics of the operability (identification of the cause of the operational problem) of the data processing service based on the received data.

The set of actions needed for the diagnostics or restoration of the operability of the service may contain one of:
a set of actions to be performed on at least one element 180 of the data transmission network;
a set of actions to be performed on at least one virtual machine 190; and
a set of actions to be performed on at least one controller 170 on which the security service for virtual machines is running.

In one aspect, the analyzer 120 transforms the identified set of actions into source code.

In step 330, by the assembler 130, method 300 creates at least one executable file 150, by performing action based on the source code and the obtained data. In one aspect, the executable file 150 comprises a file without dependencies after assembly. When the executable file 150 is a file without dependencies after assembly, the execution of the file does not require additional software packages or dynamic libraries.

In one aspect, the created executable file 150 is intended for execution on resources connected with the data processing service running in a protected virtual machine 190, the resource being:
an element 180 of the data transmission network;
a virtual machine 190; and
a controller 170 on which the security service for virtual machines is running.

In step 340, by the assembler 130, method 300 executes the created executable files 150 on resources connected with the data processing service described above, wherein the execution of the executable file 150 includes performing actions needed to identify the operational problem. In one aspect, the resource connected with the data processing service comprises an element of the data transmission network.

For the placement and execution of the file 150, agents interacting with the problem identifier 110 may be used. In one aspect, the placement and execution of the file 150 are done using the RDP or SSH protocols. Therefore, as a result of the execution of the file 150, actions which are needed to identify the operational problem (diagnostics) or eliminate the operational problem (restoration of operability) of the data processing service are performed. In one aspect, the results of the actions performed to identify the operational problems or to eliminate the operational problems are collected by the problem identifier performing of these actions in one aspect are gathered by the problem identifier 110 and sent to the analyzer 120.

In step 350, by the problem identifier 110, method 300 identifies a cause of the operational problem of the data processing service based on the results of the executions of the executable file 150.

Then, in step 360, by the analyzer 120, method 300 identifies a set of actions for eliminating the operational problem, e.g., using a decision tree. In one aspect, the analyzer 120 identifies the set of actions using a model previously trained by a machine learning method. In one aspect, the machine learning method is ordinarily known to those skilled in the relevant art. In one aspect, set of actions is identified for:
identification of methods of restoration of operability of the data processing service (identification of methods of eliminating the cause of the operational problem); and
restoration of the operability of the data processing service (eliminating the cause of the operational problem).

In one aspect, the set of actions needed for the diagnostics or restoration of the operability of the service may contain one of:
a set of actions to be performed on at least one element 180 of the data transmission network;
a set of actions to be performed on at least one virtual machine 190; and
a set of actions to be performed on at least one controller 170 on which the security service for virtual machines is running.

In one aspect, the analyzer 120 transforms the identified set of actions into source code.

In step 370, by the assembler 130, method 300 creates at least one executable file 150 for eliminating the cause of the operational problem, e.g., by performing the actions based on the source code created by transforming the results of step 360 and received data, if applicable. In one aspect, the executable file 150 is a file that does not have dependencies after being assembled.

In one aspect, the created executable file 150 is intended for execution on resources connected with the data processing service running in a protected virtual machine 190, a resource of the resources connected with the data processing service being:
an element 180 of the data transmission network;
a virtual machine 190;
a controller 170 on which the security service for virtual machines is running.

In step 380, by the assembler 130, method 300 executes the created executable files 150 on one or more resources connected with the data processing service for eliminating the cause of the operational problem.

In step 390, by the problem identifier 110, method 300 determines whether the operational problem of the data processing service has been successfully eliminated based on data containing results of the execution of the created executable files 150.

In one aspect, steps 320-390 of the present method are repeated until such time as the problem identifier 120, identifies the elimination of the operational problem of the data processing service based on data containing the results of the execution of the executable files 150. Thus, in one aspect, the method comprises identifying, by a problem identifier, an operational problem of at least one data processing service, determining, by an analyzer, a set of actions for diagnosing the operational problem and for determining a cause, identifying, by the problem identifier, the cause of the operational problem, eliminating, by an assembler, the cause of the operational problem, and determining, by the problem identifier, whether the operational problem of the data processing service has been successfully eliminated based on data containing the results of the execution of the executable files. In one aspect, the methods 320-390 are repeated until the operational problem is eliminated.

FIG. 4 is a block diagram illustrating a computer system 20 on which aspects of systems and methods for eliminating problems in operations of data processing services in a data transmission network containing virtual machines may be implemented in accordance with exemplary aspects. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 4, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for eliminating problems in operations of data processing services in a data transmission network containing virtual machines, the method comprising:
identifying, by a problem identifier, an operational problem of at least one data processing service;
determining, by an analyzer, a set of actions for diagnosing the operational problem and for determining a cause;
identifying, by the problem identifier, the cause of the operational problem;
eliminating, by an assembler, the cause of the operational problem; and
determining, by the problem identifier, whether the operational problem of the data processing service has been successfully eliminated based on data containing the results of the execution of the executable files.

2. The method of claim 1, wherein the identifying of the cause of the operational problem comprises:
creating, by the assembler, at least one executable file for performing the diagnosis based on the determined set of actions;
executing, by the assembler, the created executable files on resources connected with the data processing service for performing the diagnosis of the cause;
identifying, by the problem identifier, the cause of the operational problem of the data processing service based on results of the execution of the executable file.

3. The method of claim 1, wherein the eliminating of the cause of the operational problem comprises:
identifying, by the analyzer, a set of actions for eliminating the operational problem;
creating, by the assembler, at least one executable file for eliminating the cause of the operational problem;
executing, by the assembler, the created executable files for eliminating the cause of the operational problem on one or more resources connected with the data processing service; and
repeating, by the assembler, the method until the operational problem is eliminated.

4. The method of claim 3, wherein a resource of the one or more resources connected with the data processing service comprises one of:
an element of the data transmission network;
a virtual machine; and
a controller on which the security service for virtual machines is running.

5. The method of claim 3, wherein the executable file has no dependencies on software packages or dynamic libraries.

6. The method of claim 1, further comprising:
transforming, by the analyzer, the set of action into a source code; and
providing the source code to the assembler.

7. The method of claim 1, wherein the creation of the at least one executable file is further based on at least one of:
information gathered from agents located on a virtual machine;
information gathered from agents located on elements of the data transmission network; and
information obtained from a user of an element of the data transmission network.

8. The method of claim 1, wherein the data processing service is running on one or more virtual machines.

9. The method of claim 1, wherein the operational problem is a total inoperability of the data processing service.

10. The method of claim 1, wherein the operational problem is a partial inoperability of the data processing service.

11. A system for eliminating problems in operations of data processing services in a data transmission network containing virtual machines, comprising:
at least one processor configured to:
identifying, by a problem identifier, an operational problem of at least one data processing service;
determining, by an analyzer, a set of actions for diagnosing the operational problem and for determining a cause;
identifying, by the problem identifier, the cause of the operational problem;
eliminating, by an assembler, the cause of the operational problem; and
determining, by the problem identifier, whether the operational problem of the data processing service has been successfully eliminated based on data containing the results of the execution of the executable files.

12. The system of claim 11, the wherein the identifying of the cause of the operational problem comprises:
creating, by the assembler, at least one executable file for performing the diagnosis based on the determined set of actions;
executing, by the assembler, the created executable files on resources connected with the data processing service for performing the diagnosis of the cause;
identifying, by the problem identifier, the cause of the operational problem of the data processing service based on results of the execution of the executable file.

13. The system of claim 11, wherein the eliminating of the cause of the operational problem comprises:
identifying, by the analyzer, a set of actions for eliminating the operational problem;
creating, by the assembler, at least one executable file for eliminating the cause of the operational problem;
executing, by the assembler, the created executable files for eliminating the cause of the operational problem on one or more resources connected with the data processing service; and
repeating, by the assembler, the method until the operational problem is eliminated.

14. The system of claim 13, wherein a resource of the one or more resources connected with the data processing service comprises one of:
an element of the data transmission network;
a virtual machine; and
a controller on which the security service for virtual machines is running.

15. The system of claim 13, wherein the executable file has no dependencies on software packages or dynamic libraries.

16. The system of claim 11, the processor further configured to:
transform, by the analyzer, the set of action into a source code; and
provide the source code to the assembler.

17. The system of claim 11, wherein the creation of the at least one executable file is further based on at least one of:
information gathered from agents located on a virtual machine;
information gathered from agents located on elements of the data transmission network; and
information obtained from a user of an element of the data transmission network.

18. The system of claim 11, wherein the data processing service is running on one or more virtual machines.

19. The system of claim 11, wherein the operational problem is a total inoperability of the data processing service.

20. The system of claim 11, wherein the operational problem is a partial inoperability of the data processing service.

21. A non-transitory computer readable medium storing thereon computer executable instructions for eliminating problems in operations of data processing services in a data transmission network containing virtual machines, including instructions for:
identifying, by a problem identifier, an operational problem of at least one data processing service;
determining, by an analyzer, a set of actions for diagnosing the operational problem and for determining a cause;
identifying, by the problem identifier, the cause of the operational problem;
eliminating, by an assembler, the cause of the operational problem; and
determining, by the problem identifier, whether the operational problem of the data processing service has been successfully eliminated based on data containing the results of the execution of the executable files.
